(19) United States
(12) Patent Application Publication
(10) Pub. No.: US 2013/0198271 A1
(43) Pub. Date: Aug. 1, 2013

(54) System, Method, and Implementation of providing Network-based Alarm Clock

(71) Applicants: Mengyuan Yu, Fremont, CA (US); Sierra JY Lou, Fremont, CA (US); LingZhen Zhao, San Francisco, CA (US)

(72) Inventors: Mengyuan Yu, Fremont, CA (US); Sierra JY Lou, Fremont, CA (US); LingZhen Zhao, San Francisco, CA (US)

(21) Appl. No.: 13/802,761

(22) Filed: Mar. 14, 2013

(51) Int. Cl. H04L 29/08

(52) U.S. Cl. CPC H04L 67/10
USPC 709/203

(57) ABSTRACT

A system, method, and implementation provides a network-based alarm clock in addition to providing alarm clock for awakening a user, wherein the network-based alarm clock connects with a network alarm server via a communication network to provide network alarm clock functions and to provide statistic ranks for the user in response to stopping a sounding alarm.

### BACKGROUND OF THE PRESENT INVENTION

1.Field of Invention

The present invention relates to the field of alarm clock, and more particularly to system and method of providing network-based alarm clock for awakening a user.

2. Description of Related Arts

In the current alarm clock field, with the growing popularity of mobile devices such as digital watch, MP3/MP4 players, portable GPS, notebook and tablet computers, cell phones and smart phones having built in alarm clock, people are using these mobile devices as alarm clock devices for awakening the user(s) from sleep. These alarm clock devices can play a multimedia stored locally as an alarm sound. However, none of these alarm clock devices have network connection ability to provide network alarm clock functions for users.

Whereas, the presented network-based alarm clock, in addition to providing alarm clock functions for awakening a user, has a network connection ability that provide network alarm clock functions, such as collecting alarm response data from the user in response to stopping a sounding alarm, sending the alarm response data to an alarm clock server through a communication network and receiving statistic and analytic data from the alarm clock server, and selecting a multimedia from a multimedia server to be played as alarms sound, wherein the statistic and analytic data is for a wake-up ranking for user in response to stopping a sounding alarm.

Additionally, the presented invention allows user to use the network-based alarm clock as a social network tool or a closed user group tool, allows an administrator from the alarm clock server to centralize setting an alarm clock for all users in the alarm clock server or in the closed user group, and provides the wake-up ranking for the users within a network or a closed user group.

### SUMMARY OF THE PRESENT INVENTION

An object of this invention is to provide a system and method to implement network-based alarm clock.

The series of solutions of the present invention are:

A network-based alarm clock, in addition to providing alarm clock functions for awakening a user, connects with a communication network, collects alarm response data from the user in response to stopping a sounding alarm, and communicates with an alarm clock server via the communication network, wherein the alarm clock server provides profile management for the user and receives the alarm response data.

Accordingly, the alarm response data is an accumulated elapsed time taken by the user to use a stopping operation to stop the sounding alarm, or an accumulated elapsed time with a cancellation flag taken by said user to use a cancellation operation to cancel a scheduled alarm during the scheduled alarm activation, for a puzzle lock associated with the stopping operation is enabled, the accumulated elapsed time and the accumulated elapsed time with a cancellation flag deducts the puzzle lock appearing elapsed time.

Accordingly, the alarm clock server further processes received the alarm response data and sends statistic and analytic data to the network-based alarm clock, wherein the statistic and analytic data is used to provide a ranking.

Accordingly, the network-based alarm clock further receives message from the alarm clock server.

Accordingly, the alarm clock server further enables an administrator to create a closed user group as a group of the network-based alarm clock(s), enables the administrator to manage the profile of the closed user group and to set the each of network-based alarm clock of the closed user group through the communication network.

Accordingly, the network-based alarm clock system further has Instant Message (IM) communication functions.

Accordingly, the network-based alarm clock further comprises a menu option for selecting network multimedia, for the network multimedia is set to enable, the network-based alarm clock plays a network multimedia as an alarm sound from a multimedia server for sounding alarm, for the network multimedia is set to disable, the network-based alarm clock plays a local multimedia stored in the network-based alarm clock as an alarm sound for sounding alarm.

A system of an interactive alarm clock added on user terminal, in addition to providing the alarm clock functions for awakening the user, records a stopping elapsed time taken by the user in response to stopping the sounding alarm, records a cancellation elapsed time taken by the user to cancel the scheduled alarm during the scheduled alarm activation, records a snoozing elapsed time taken by the user to snooze the sounding alarm, counts a repeating number of the sounding alarm been played during the scheduled alarm activation, connects with the alarm clock server, and sends the alarm clock data to the alarm clock server.

Accordingly, the alarm clock data is the stopping elapsed time, the cancellation elapsed time, the snoozing elapsed time or the repeating number.

Accordingly, the alarm clock server further processes received the alarm clock data and sends statistic and analytic data to the interactive alarm clock, wherein the statistic and analytic data is used to represent a ranking, wherein the alarm clock server further coordinates each of the interactive alarm clock(s) and analyzes the user's reactions in response to stopping the sounding alarm.

Accordingly, the alarm clock server further enables someone permitted by the user to set the user's alarm clock through a network.

Accordingly, the system of the interactive alarm clock added on user terminal further has ability to send and receive Instant Message (TM) through the alarm clock server.

Accordingly, the interactive alarm clock further comprises a menu option for selecting network multimedia, for the network multimedia is set to enable, the interactive alarm clock plays a network multimedia as an alarm sound from a multimedia server for sounding alarm, for the network multimedia is set to disable, the interactive alarm clock plays a local multimedia stored in the interactive alarm clock as an alarm sound for sounding alarm.

An alarm clock communication system where the network-based alarm clock and interactive alarm clock added on user terminal provide network alarm clock functions, comprising:

a communication network;

an alarm clock server, connecting with the communication network;

a plurality of network-based alarm clocks communicatively linking with the communication network, wherein each of the network-based alarm clocks, in addition to providing the alarm clock functions for awakening the user, connects with the communication network, collects the alarm response data from the user in response to stopping the sounding alarm and communicates with the alarm server; and

a plurality of interactive alarm clocks, wherein each of the interactive alarm clocks, in addition to providing the alarm clock functions for awakening said user, records the stopping elapsed time from the user in response to stopping the sounding alarm, records the cancellation elapsed time taken by the user to cancel the scheduled alarm during the scheduled alarm activation, records the snoozing elapsed time taken by the user to snooze the sounding alarm, counts the repeating number of the sounding alarm been played during the scheduled alarm activation, connects with the alarm clock server, and sends the alarm clock data to the alarm clock server.

Preferably, the interactive alarm clocks are not communicatively linked with the communication network. However, the interactive alarm clocks can communicatively link with the communication network.

Accordingly, the alarm clock communication system further comprises a multimedia server, provides the network multimedia to the network-based alarm clocks and the interactive alarm clocks.

A network-managed alarm clock, in addition to providing alarm clock functions for awakening the user, connects with the communication network, and communicates with the alarm clock server via the communication network to exchange information, wherein the user sets the alarm clock schedule through the alarm clock server when desired.

A method of implementing a network-based alarm clock, comprising the steps of:

(a) for the scheduled alarm time is reached, sounding alarm by playing a multimedia as an alarm sound for awakening the user, and starting to record the accumulated elapsed time taken by the user in response to stopping the sounding alarm;

(b) for detecting the stop operation from the user, stopping playing the multimedia to stop the sounding alarm, deactivating the scheduled alarm and stopping to record the accumulated elapsed time; and

(c) sending out the alarm clock data through the communication network to a preset network address, wherein the alarm clock data comprises the accumulated elapsed time.

Accordingly, before the step (a), further comprising a step of setting the menu option for selecting the network multimedia, for the network multimedia is set to enable, the network-based alarm clock plays the network multimedia as an alarm sound from the multimedia server when the scheduled alarm time is reached, for the network multimedia is set to disable, the network-based alarm clock plays the local multimedia stored in the network-based alarm clock as an alarm sound when the scheduled alarm time is reached.

Accordingly, in the step (b), for detecting the cancellation operation to cancel the scheduled alarm during the activation of the scheduled alarm, sending out the accumulated elapsed time with the cancellation flag to the network address through the communication network.

Accordingly, in step (c), the network address is designated to the alarm clock server, wherein the alarm clock server manages the user profile, receives the accumulated elapsed time, receives the accumulated elapsed time with the cancellation flag, and processes received the alarm clock data and sends the statistic and analytic data to the network-based alarm clock.

Accordingly, when receiving the statistic and analytic data from the alarm clock server, the network-based alarm clock displays interactive messages to the user.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an architectural diagram of the system of network-based alarm clock.

FIG. 2 is an architectural diagram of the system of interactive alarm clock added on user terminal.

FIG. 3 is an architectural diagram of the system of network-managed alarm clock.

FIG. 4 is an architectural diagram of the embodiment of the network-based alarm clock.

FIG. 5 is an architectural diagram of the embodiment of the interactive alarm clock.

FIG. 6 is an architectural diagram of the embodiment of the network-managed alarm clock.

FIG. 7 is a flow chart illustrating the steps of setting the network-based alarm clock.

FIG. 8 is a flow chart illustrating the steps of setting the interactive alarm clock.

FIG. 9 is a flow chart of configuration on alarm clock server for setting network-based alarm clock.

FIG. 10 is a perspective view of ranking table illustrating a social-network-wide in current day ranking for the user in response to stopping a sounding alarm.

FIG. 11 is a perspective view of ranking table illustrating a social-network-wide in all-time ranking for the user in response to stopping a sounding alarm.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

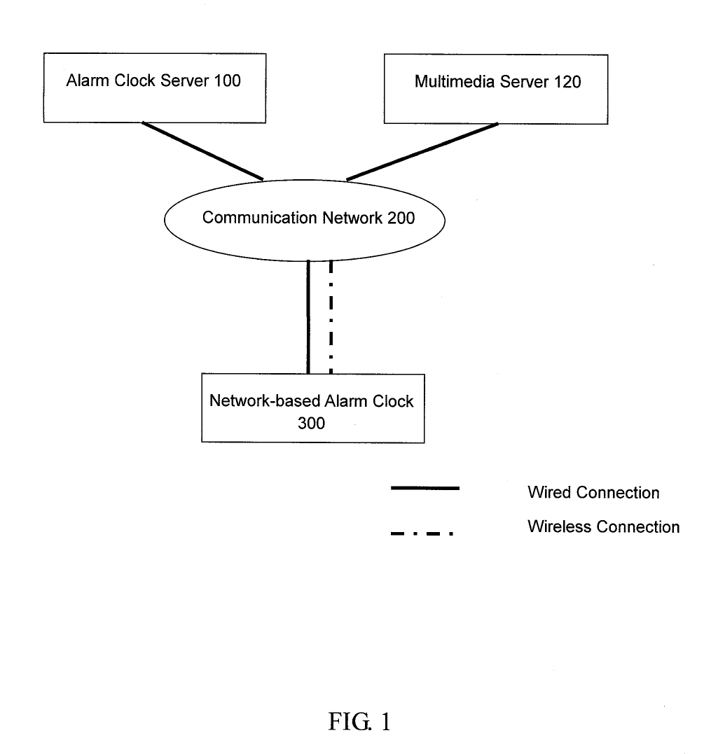

Referring to FIG. 1 of the drawings, an architectural diagram of the system of network-based alarm clock is illustrated, wherein the network-based alarm clock 300, in addition to providing alarm clock functions for awakening a user, connects with a communication network 200, collects alarm response data from the user in response to stopping a sounding alarm, and communicates with an alarm clock server 100 via the communication network 200. The alarm clock server 100, communicatively connected with the network-based alarm clock 300, provides profile management for the user and receives the alarm response data. Accordingly, the network-based alarm clock 300 can be an application installed into a smart phone for providing alarm clock functions.

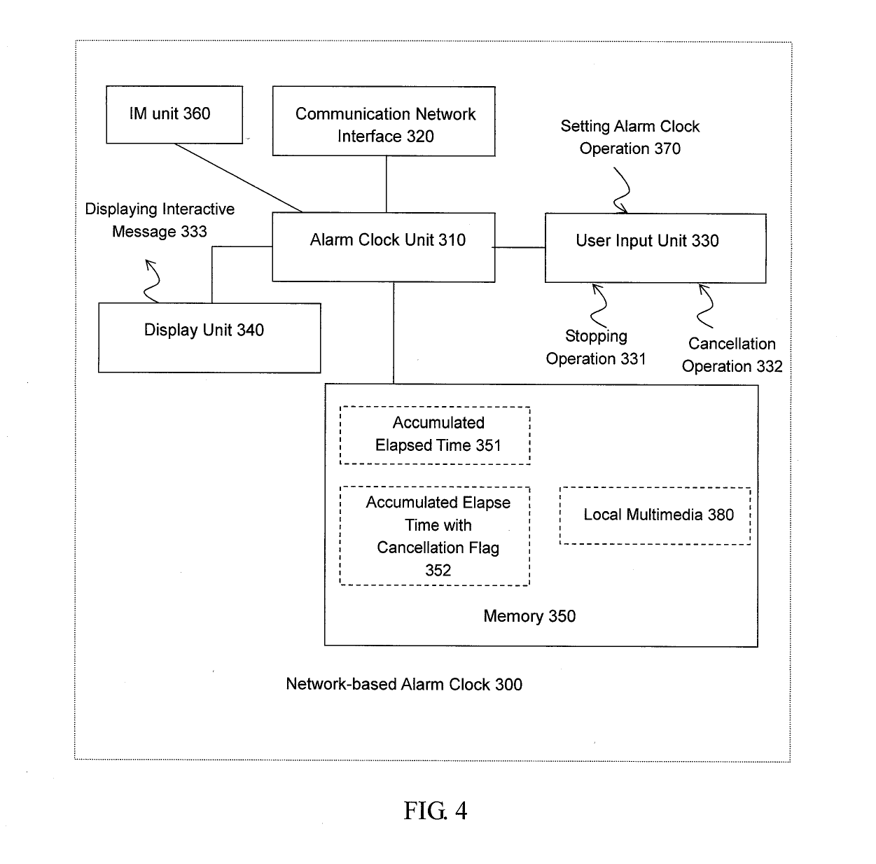

Referring to FIG. 4 of the drawings, which is an architectural diagram of the embodiment of the network-based alarm clock.

Accordingly, the alarm response data is an accumulated elapsed time 351, which is stored in memory 350, taken by the user to use a stopping operation 331 to stop the sounding alarm, or an accumulated elapsed time with a cancellation flag 352, which is stored in memory 350, taken by said user to use a cancellation operation 332 to cancel a scheduled alarm during the scheduled alarm activation, for a puzzle lock associated with the stopping operation 331 is enabled, the accumulated elapsed time 351 and the accumulated elapsed time with a cancellation flag 352 deducts the puzzle lock appearing elapsed time.

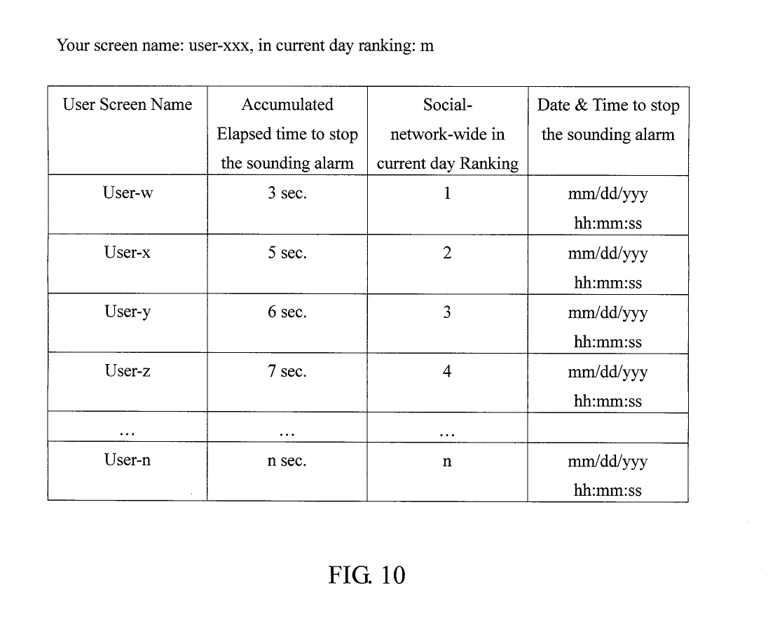

Referring to FIG. 10, a perspective view of ranking table illustrates a social-network-wide in current day ranking for the user in response to stopping a sounding alarm.

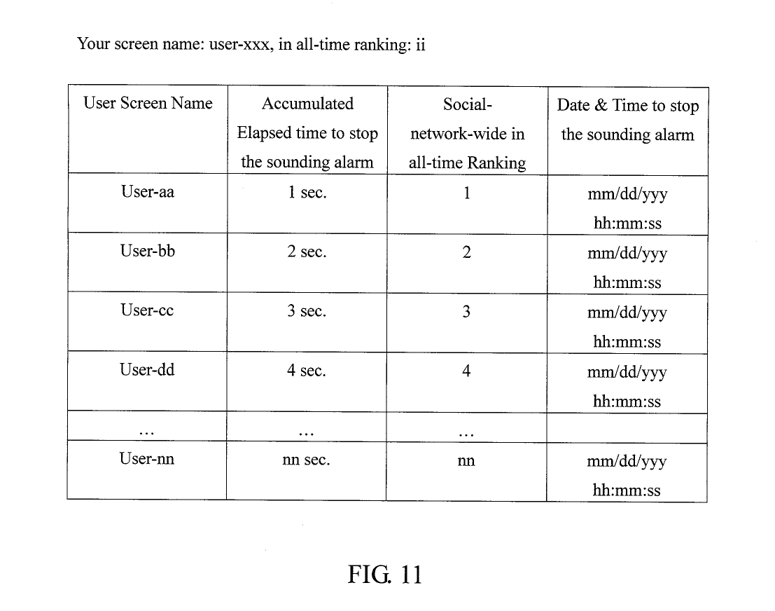

Referring to FIG. 11, a perspective view of ranking table illustrates a social-network-wide in all-time ranking for the user in response to stopping a sounding alarm.

Accordingly, the alarm clock server 100 further processes received the alarm response data and sends statistic and analytic data to the network-based alarm clock 300, wherein the statistic and analytic data is used to provide the ranking for in current day ranking or for in all-time ranking within a social network or within a closed user group.

Accordingly, the network-based alarm clock 300 further receives message from the alarm clock server 100.

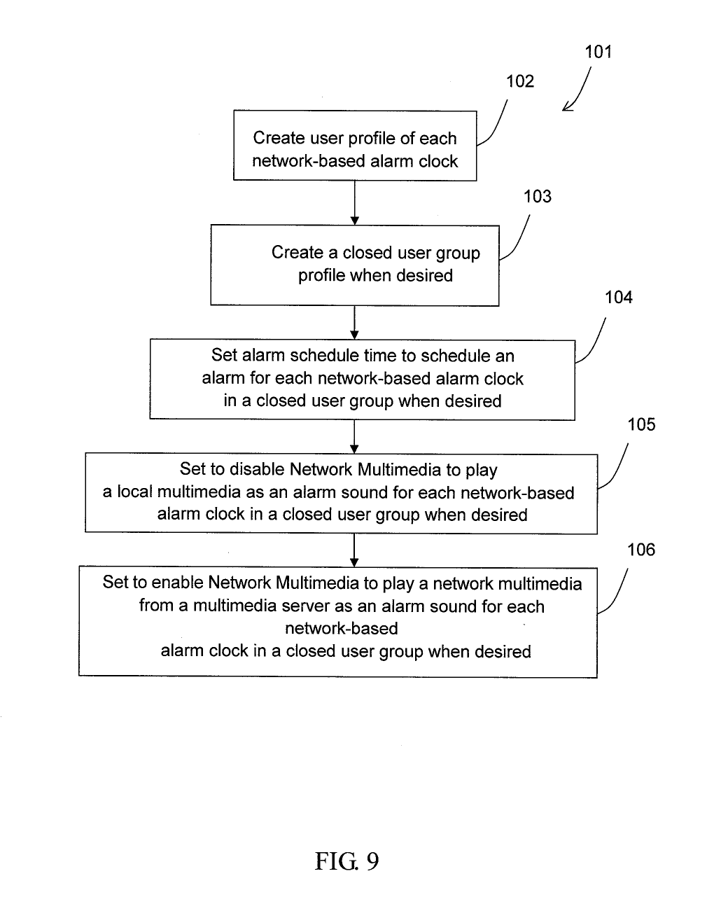

Referring to FIG. 9 of drawings, which is a flow chart of configuration on alarm clock server for setting network-based alarm clock.

Accordingly, the alarm clock server 100 further enables an administrator to create a closed user group as a group of the network-based alarm clock(s) 300 referring to flow chart of configuration 103, enables the administrator to manage the profile of the closed user group and to set the each of network-based alarm clock 300 of the closed user group through the communication network 200, referring to flow chart of configuration 104, 105, and 106.

Accordingly, the network-based alarm clock 300 further has Instant Message (IM) communication functions implemented through IM unit 360.

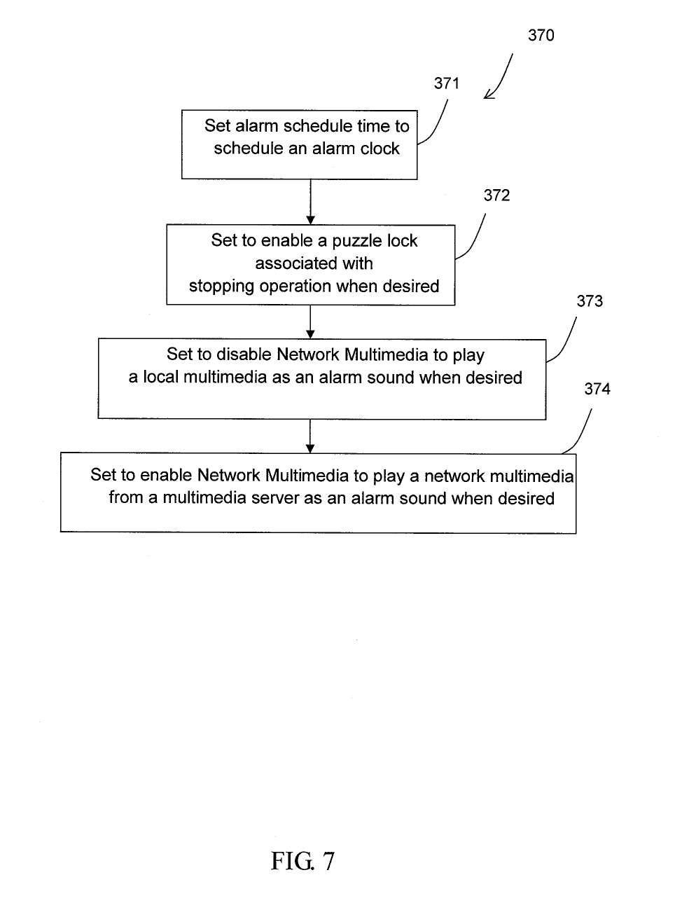

FIG. 7 illustrates a flow chart of the steps for setting the network-based alarm clock 300.

Accordingly, the network-based alarm clock 300 further comprises a menu option for selecting network multimedia, for the network multimedia is set to enable, referring to flow chart the steps of setting 374, the network-based alarm clock 300 plays a network multimedia as an alarm sound from a multimedia server 120 for sounding alarm, for the network multimedia is set to disable, referring to flow chart the steps of setting 373, the network-based alarm clock plays a local multimedia 380 stored in the network-based alarm clock 300 as an alarm sound for sounding alarm.

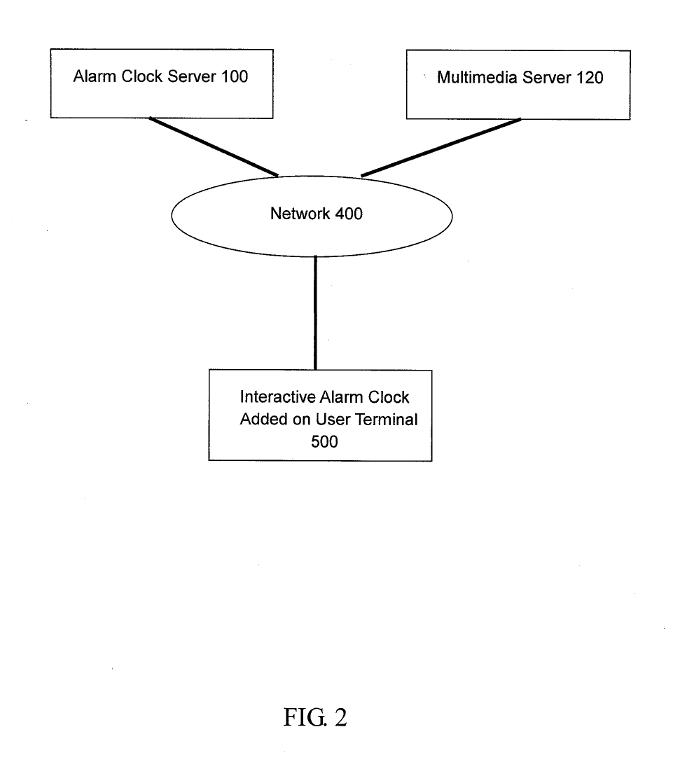

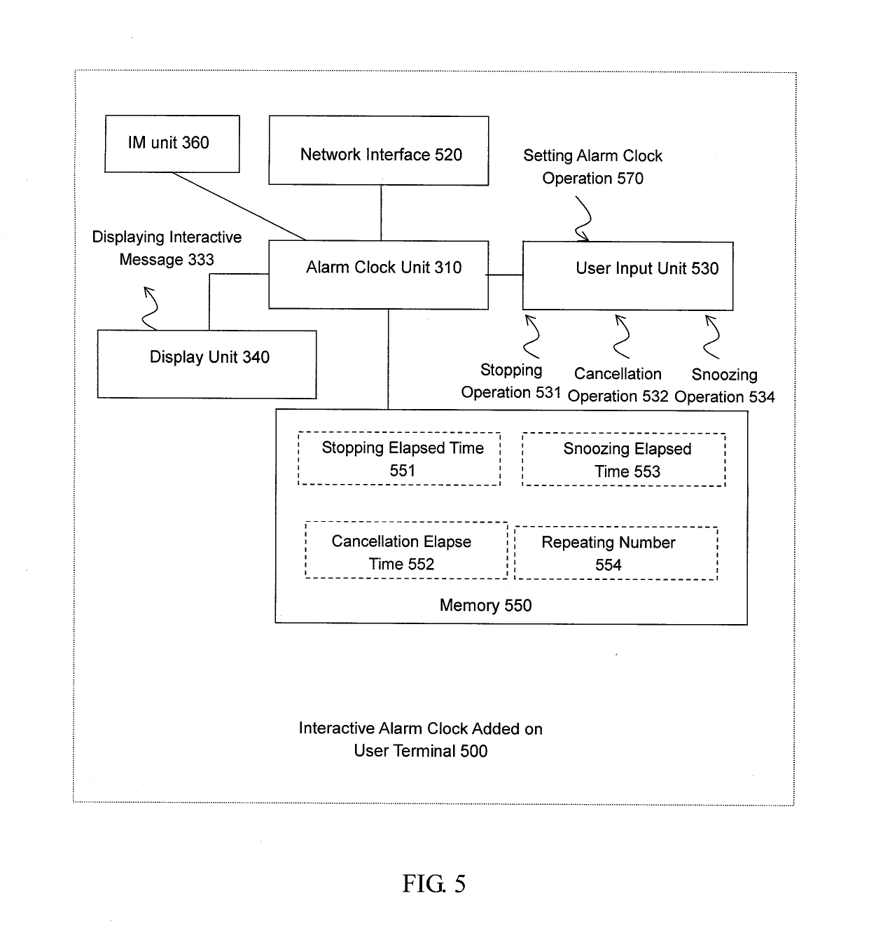

Referring to FIG. 2 of the drawings, an architectural diagram of the system of interactive alarm clock added on user terminal is illustrated, and referring to FIG. 5 of the drawings, which is an architectural diagram of the embodiment of the interactive alarm clock added on user terminal, wherein the interactive alarm clock added on user terminal 500, in addition to providing the alarm clock functions for awakening the user, records a stopping elapsed time 551, which is stored in memory 550, taken by the user in response to stopping the sounding alarm, records a cancellation elapsed time 552, which is stored in memory 550, taken by the user to cancel the scheduled alarm during the scheduled alarm activation, records a snoozing elapsed time 553, which is stored in memory 550, taken by the user to snooze the sounding alarm, counts a repeating number 554 of the sounding alarm, which is stored in memory 550, been played during the scheduled alarm activation, connects with the alarm clock server 100, and sends the alarm clock data to the alarm clock server 100, wherein, the user terminal is digital watch, digital clock, desktop computer, laptop computer, notebook computer, netbook computer, tablet computer, mobile phone, smart phone, MP3/MP4 player, portable CD/DVD player or portable GPS.

Accordingly, the alarm clock data is the stopping elapsed time 551, the cancellation elapsed time 552, the snoozing elapsed time 553 or the repeating number 554.

Accordingly, the alarm clock server 100 further processes received the alarm clock data and sends statistic and analytic data to the interactive alarm clock 500, wherein the statistic and analytic data is used to represent a ranking for in current day ranking or for in all-time ranking within a social network or within a closed user group, wherein the alarm clock server 100 further coordinates each of the interactive alarm clock(s) 500 and analyzes the user's reactions in response to stopping the sounding alarm.

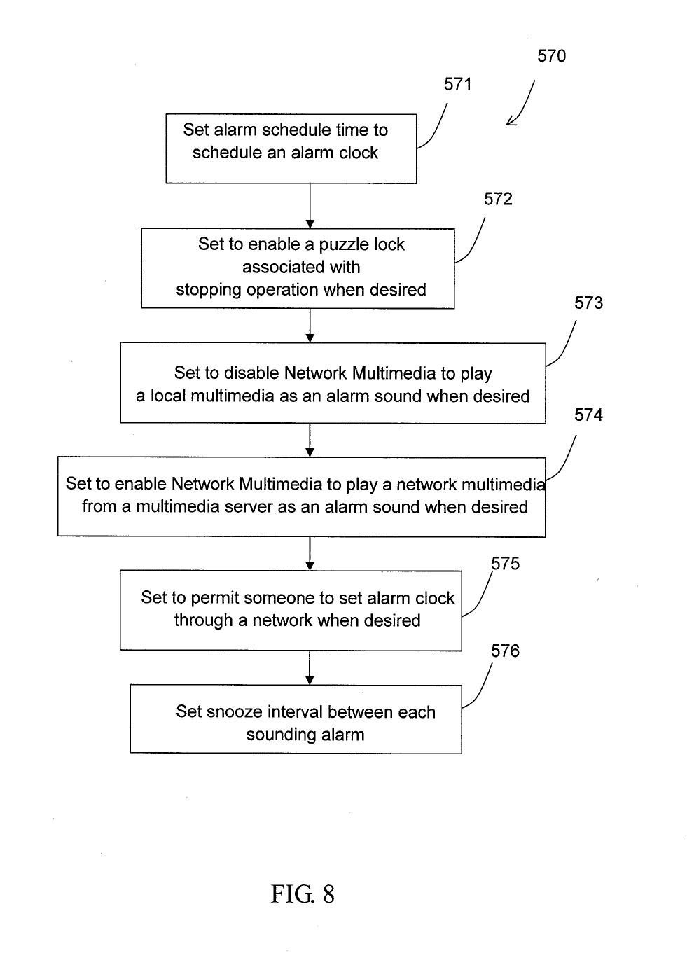

FIG. 8 illustrates a flow chart of the steps for setting the interactive alarm clock 500.

Accordingly, the alarm clock server 100 further enables someone permitted by the user to set the user's alarm clock through a network, referring to flow chart the steps of setting 575.

Accordingly, the interactive alarm clock added on user terminal 500 further has ability to send and receive Instant Message (IM) by using IM unit 360 through the alarm clock server 100.

Accordingly, the interactive alarm clock 500 further comprises a menu option for selecting the network multimedia, referring to flow chart the steps of setting 574, for the network multimedia is set to enable, the interactive alarm clock 500 plays the network multimedia as an alarm sound from the multimedia server 120 for sounding alarm, for the network multimedia is set to disable, referring to flow chart the steps of setting 573, the interactive alarm clock plays the local multimedia stored in the interactive alarm clock as an alarm sound for sounding alarm.

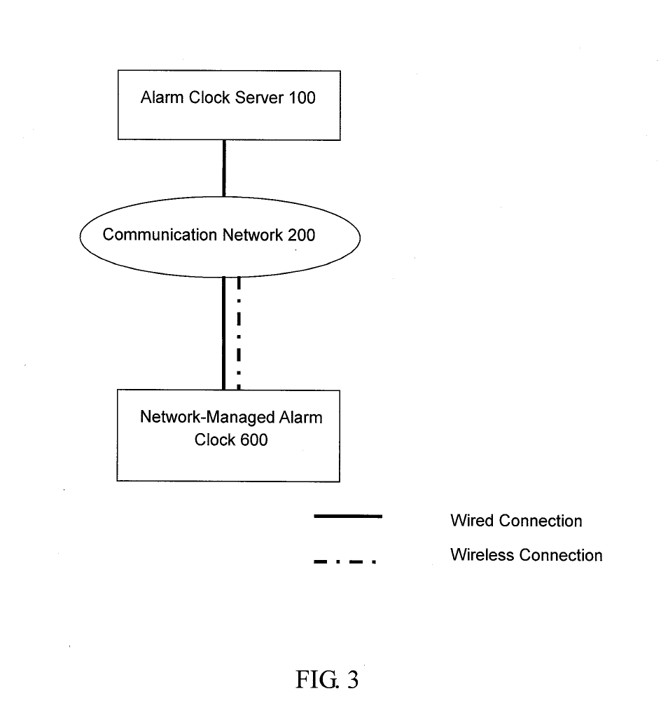

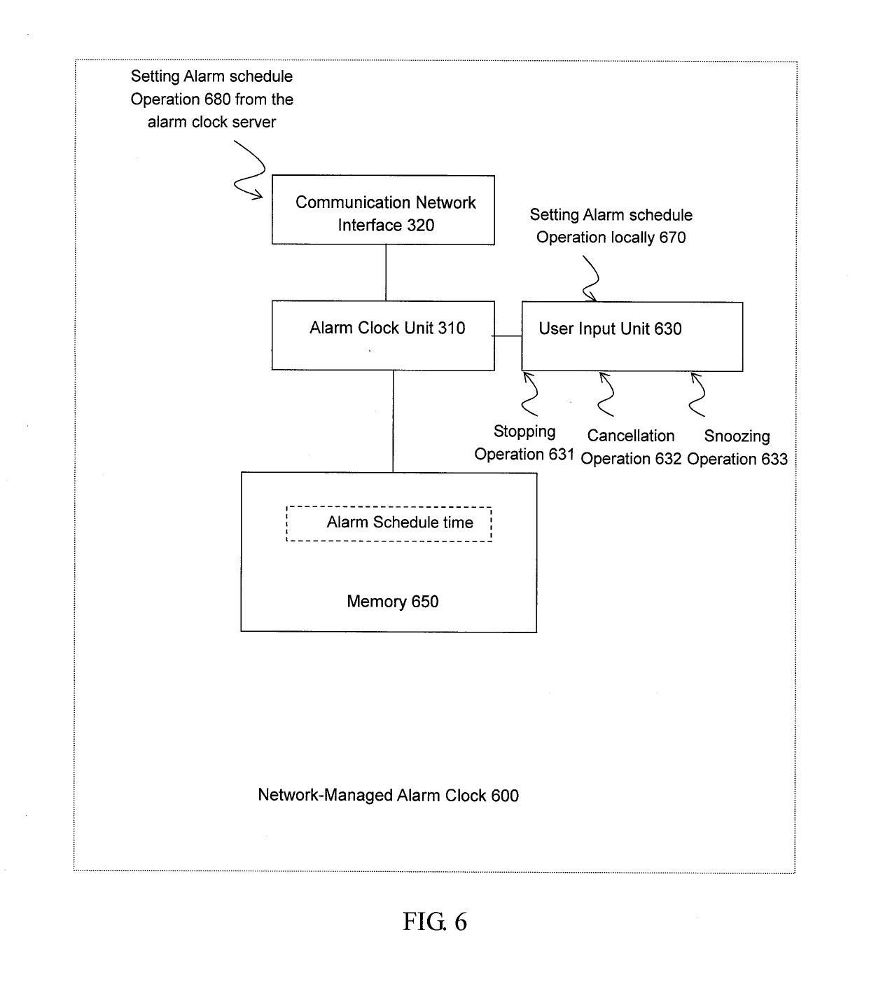

Referring to FIG. 3 of the drawings, an architectural diagram of the system of network-managed alarm clock is illustrated, and referring to FIG. 6 of the drawings, which is an architectural diagram of the embodiment of the network-managed alarm clock, wherein the network-managed alarm clock, in addition to providing alarm clock functions for awakening the user, connects with the communication network, communicates with the alarm clock server 100 via the communication network 200 to exchange information, wherein the user sets the network-managed alarm clock's 300 schedule through the alarm clock server 100 when desired.

An alarm clock communication system, in which the network-based alarm clock 300 and interactive alarm clock added on user terminal 500 provide network alarm clock functions, comprising:

a communication network 200, wherein, the communication network 200 is Internet, telecommunication network, telecommunication data network, wireless network, wireless data network, mobile network, WiMAX, wired local area network, wireless local area network, WiFi or Bluetooth;

an alarm clock server 100, connecting with the communication network;

a plurality of network-based alarm clocks 300 communicatively linking with the communication network 200, wherein each of the network-based alarm clocks 300, in addition to providing the alarm clock functions for awakening the user, connects with the communication network 200, collects the alarm response data from the user in response to stopping the sounding alarm and communicates with the alarm server 100; and a plurality of interactive alarm clocks 500, wherein each of the interactive alarm clocks 500, in addition to providing the alarm clock functions for awakening the user, records the stopping elapsed time 551 from the user in response to stopping the sounding alarm, records the cancellation elapsed time 552 taken by the user to cancel the scheduled alarm during the scheduled alarm activation, records the snoozing elapsed time 553 taken by the user to snooze the sounding alarm, counts the repeating number 554 of the sounding alarm been played during the scheduled alarm activation, connects with the alarm clock server 100, and sends the alarm clock data to the alarm clock server 100.

Accordingly, the interactive alarm clocks 500 are not communicatively linked with the communication network 200. However, the interactive alarm clocks 500 can communicatively link with the communication network 200.

Accordingly, the alarm clock communication system further comprises a multimedia server 120, provides the network multimedia to the network-based alarm clocks 300 and the interactive alarm clocks 500.

A network-managed alarm clock 600, in addition to providing alarm clock functions for awakening the user, connects with the communication network 200, and communicates with the alarm clock server 100 via the communication network 200 to exchange information, wherein the user sets the network-managed alarm clock's schedule through the alarm clock server 100 when desired.

A method of implementing a network-based alarm clock, comprising the steps of:

(a) for the scheduled alarm time is reached, sounding alarm by playing a multimedia as an alarm sound for awakening the user, and starting to record the accumulated elapsed time 351 taken by the user in response to stopping the sounding alarm;

(b) for detecting the stop operation 331 from the user, stopping playing the multimedia to stop the sounding alarm, deactivating the scheduled alarm and stopping to record the accumulated elapsed time 351; and

(c) sending out the alarm clock data through the communication network 200 to a preset network address, wherein the alarm clock data comprises the accumulated elapsed time 351.

Accordingly, before the step (a), further comprising a step of setting the menu option for selecting the network multimedia, referring to flow chart the steps of setting 374, for the network multimedia is set to enable, the network-based alarm clock plays the network multimedia as an alarm sound from the multimedia server 120 when the scheduled alarm time is reached, for the network multimedia is set to disable, referring to flow chart the steps of setting 373, the network-based alarm clock 300 plays the local multimedia stored in the network-based alarm clock 300 as an alarm sound when the scheduled alarm time is reached.

Accordingly, in the step (b), for detecting the cancellation operation 332 to cancel the scheduled alarm during the activation of the scheduled alarm, sending out the accumulated elapsed time with the cancellation flag 352 to the network address through the communication network 200.

Accordingly, in step (c), the network address is designated to the alarm clock server 100, wherein the alarm clock server 100 manages the user profile, receives the accumulated elapsed time 351, receives the accumulated elapsed time with the cancellation flag 352, and processes received the alarm clock data and sends the statistic and analytic data to the network-based alarm clock 300.

Accordingly, when receiving the statistic and analytic data from the alarm clock server 100, the network-based alarm clock 300 displays interactive messages to the user through display unit 340.

One skilled in the art will understand that the embodiment of the present invention as shown in the drawing and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A network-based alarm clock system, comprising:
a network-based alarm clock providing alarm clock functions for awakening a user;
means for collecting alarm response data from said user in response to stopping a sounding alarm; and
an alarm clock server providing profile management for said user and receiving said alarm response data, wherein said network-based alarm clock, means for collecting alarm response data, and said alarm clock server are networked with a communication network.

2. The network-based alarm clock system, as recited in claim 1, wherein said alarm response data comprises an accumulated elapsed time taken by said user to use a stopping operation to stop said sounding alarm, and an accumulated elapsed time with a cancellation flag taken by said user to use a cancellation operation to cancel a scheduled alarm during said scheduled alarm activation, wherein when a puzzle lock associated with said stopping operation is set to enable by said user, said accumulated elapsed time and said accumulated elapsed time with a cancellation flag deducts said puzzle lock appearing elapsed time.

3. The network-based alarm clock system, as recited in claim 1, wherein said alarm clock server further processes received said alarm response data and sends statistic and analytic data to said network-based alarm clock, wherein said statistic and analytic data is used to provide a ranking.

4. The network-based alarm clock system, as recited in claim 1, wherein said network-based alarm clock further receives messages from said alarm clock server.

5. The network-based alarm clock system, as recited in claim 1, wherein said alarm clock server further enables an administrator to create a closed user group as a group of said network-based alarm clock(s), enables said administrator to manage profile of said closed user group and enables said administrator to set each said network-based alarm clock of said closed user group through said communication network.

6. The network-based alarm clock system, as recited in claim 1, wherein said network-based alarm clock further has Instant Message (IM) communication functions.

7. The network-based alarm clock system, as recited in claim 1, wherein said network-based alarm clock further comprises a menu option for selecting network multimedia, when said network multimedia is set to enable, said network-based alarm clock plays a network multimedia as an alarm sound from a multimedia server, wherein when said network multimedia is set to disable, said network-based alarm clock plays a local multimedia stored therein as an alarm sound.

8. An interactive alarm clock system, comprising:
an interactive alarm clock added on user terminal providing alarm clock functions for awakening a user, wherein said interactive alarm clock comprises means for recording a stopping elapsed time taken by said user in response to stopping a sounding alarm, means for recording a cancellation elapsed time taken by said user to cancel a scheduled alarm during activation of said scheduled alarm, means for recording a snoozing elapsed time taken by said user to snooze said sounding alarm, and means for counting a repeating number of said sounding alarm been played during activation of said scheduled alarm; and
an alarm clock server, which provides profile management for said user, connecting to said interactive alarm clock, wherein said interactive alarm clock sends alarm clock data to said alarm clock server.

9. The interactive alarm clock system, as recited in claim 8, wherein said alarm clock data is selected from the group consisting of said stopping elapsed time, said cancellation elapsed time, said snoozing elapsed time and said repeating number.

10. The interactive alarm clock system, as recited in claim 8, wherein said alarm clock server further processes received said alarm clock data and sends statistic and analytic data to said interactive alarm clock, wherein said statistic and analytic data is used to represent a ranking, wherein said alarm clock server further coordinates each of said interactive alarm clock(s) and analyzes said user's reactions in response to stopping said sounding alarm.

11. The interactive alarm clock system, as recited in claim 8, wherein said alarm clock server further enables someone permitted by said user to set said interactive alarm clock thereof through a network.

12. The interactive alarm clock system, as recited in claim 8, wherein said interactive alarm clock further comprises means for sending and receiving Instant Message (IM) through said alarm clock server.

13. The interactive alarm clock system, as recited in claim 8, wherein said interactive alarm clock further comprises a menu option for selecting network multimedia, wherein when said network multimedia is set to enable, said interactive alarm clock plays a network multimedia as an alarm sound from a multimedia server, wherein when said network multimedia is set to disable, said interactive alarm clock plays a local multimedia stored therein as an alarm sound.

14. A network-managed alarm clock system, comprising:
a network-based alarm clock providing alarm clock functions for awakening a user; and
an alarm clock server communicatively connecting to said network-based alarm clock via a communication network to exchange information between said network-based alarm clock and said alarm clock server, wherein a schedule of said network-based alarm clock is selectively set through said alarm clock server.

15. An alarm clock communication system, comprising:
an alarm clock server;
a plurality of network-based alarm clocks communicatively linking with said alarm clock server via a communication network, wherein each of said network-based alarm clocks, which provides alarm clock functions for awakening a user, comprises means for collecting alarm response data from said user in response to stopping a sounding alarm; and
a plurality of interactive alarm clocks, each of said interactive alarm clocks linked to said alarm clock server, each of said interactive alarm clocks providing alarm clock functions for awakening said user and comprising means for recording a stopping elapsed time from said user in response to stopping said sounding alarm, means for recording a cancellation elapsed time taken by said user to cancel a scheduled alarm during activation of said scheduled alarm, means for recording a snoozing elapsed time taken by said user to snooze said sounding alarm, means for counting a repeating number of said sounding alarm been played during activation of said scheduled alarm, and means for sending alarm clock data to said alarm clock server.

16. The alarm clock communication system, as recited in claim 15, further comprising a multimedia server, wherein said multimedia server connects with said communication network, and provides network multimedia to said network-based alarm clocks and said interactive alarm clocks.

17. A method of implementing a network-based alarm clock, comprising the steps of:
(a) when a scheduled alarm time is reached, sounding alarm by playing a multimedia as an alarm sound for awakening a user, and starting to record an accumulated elapsed time taken by said user in response to stopping said sounding alarm;
(b) when detecting a stop operation from said user, stopping playing said multimedia to stop said sounding alarm, and stopping to record said accumulated elapsed time; and
(c) sending out alarm clock data through a communication network to a preset network address, wherein said alarm clock data comprises said accumulated elapsed time.

18. The method, as recited in claim 17, before the step (a), further comprising a step of setting a menu option for selecting network multimedia, wherein when said network multimedia is set to enable, said network-based alarm clock plays a network multimedia as an alarm sound from a multimedia server when said scheduled alarm time is reached, wherein when said network multimedia is set to disable, said network-based alarm clock plays a local multimedia stored therein as an alarm sound when said scheduled alarm time is reached.

19. The method as recited in claim 17 wherein, in the step (b), when detecting a cancellation operation to cancel a scheduled alarm during activation of said scheduled alarm, sending out said accumulated elapsed time with a cancellation flag to said network address through said communication network.

20. The method as recited in claim 17, wherein, in step (c), said network address is designated to an alarm clock server, wherein said alarm clock server manages said user profile, receives said accumulated elapsed time, receives said accumulated elapsed time with said cancellation flag, and processes received said alarm clock data and sends statistic and analytic data related to said time(s) to said network-based alarm clock.

21. The method as recited in claim 17, wherein when receiving said statistic and analytic data from said alarm clock server, said network-based alarm clock displays interactive messages to said user.
